(19) United States
(12) Patent Application Publication
(10) Pub. No.: US 2014/0089086 A1
(43) Pub. Date: Mar. 27, 2014

(54) GIFT-RECOMMENDATION APPARATUS AND METHOD

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/625,593

(22) Filed: Sep. 24, 2012

(51) Int. Cl. G06Q 30/02

(52) U.S. Cl. 705/14.53

(57) ABSTRACT

A method for using receipt data within a social network is disclosed. The method may include obtaining, by a computer system, access to a computer-hosted social networking service. The computer system may also obtain access to receipt data documenting one or more purchases made by a first human user of the social networking service. The receipt data may be classified. Based at least in part on the classifications produced, the computer system may generate one or more recommendations for gifts for the first human user. Accordingly, the computer system may present, via the social networking service, the one or more recommendations to a second human user of the social networking service.

### BACKGROUND

1. Field of the Invention

This invention relates to gift-recommendation systems and more particularly to systems and methods for leveraging receipt data when making gift recommendations.

2. Background of the Invention

Many point-of-sale (POS) and back office systems currently in use today do not support important emerging technologies, services, and marketing opportunities. For example, many POS and back office systems are limited in their ability to leverage the electronic receipt data they collect. Accordingly, what is needed is an apparatus and method expanding the ability of a wide variety of POS and back office systems, include legacy systems, to make improved use of the receipt data they collect.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a point-of-sale (POS) system for implement methods in accordance with the present invention;

FIG. 2 is a schematic block diagram of one embodiment of multiple POS systems in accordance with the present invention operating in the context of an enterprise-wide system;

FIG. 3 is a schematic block diagram of one embodiment of a receipt in accordance with the present invention;

FIG. 4 is a schematic block diagram of one embodiment of a receipt module in accordance with the present invention;

FIG. 5 is a schematic block diagram of one embodiment of a recommendation module in accordance with the present invention;

FIG. 6 is a block diagram of one embodiment of a method for leveraging electronic receipt data to identify and communicate gift ideas;

FIG. 7 is a schematic diagram illustrating the flow of certain data within one embodiment of a system in accordance with the present invention;

FIG. 8 is a schematic diagram illustrating the flow of certain data within an alternative embodiment of a system in accordance with the present invention; and

FIG. 9 is a schematic diagram illustrating the flow of certain data within another alternative embodiment of a system in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for leveraging receipt data collected at a POS. For example, in selected embodiments, a customer may enter a “brick-and-mortar” business location and approach a POS system to begin a transaction. As part of the transaction, the customer may be identified and receipt data may be generated. The receipt data may identify one or more items purchase by the customer. Identification information may link a customer and receipt data corresponding thereto.

In selected embodiments, receipt data may be leveraged by a computer system to assist in making recommendations that are relevant to a customer corresponding to the receipt data. For example, a recommendation may comprise an identification of a commercially available product or service that may be a timely, appropriate, and relevant gift for the customer. Accordingly, a system may leverage receipt data to serve both a customer and his or her friends by facilitating and improving a gifting process.

One method in accordance with the present invention may begin with obtaining access to a computer-hosted social networking service. Access may also be obtained to receipt data documenting one or more purchases made by a first human user of the social networking service. Accordingly, to better understanding the interests of the first user, a computer system may analyze the receipt data.

Following the analysis, the computer system may have the information necessary to generate one or more recommendations. For example, the computer system may identify, based at least in part on certain past purchases of the first user, one or more gifts that may be well suited to the first user. Once one or more recommendations have been generated, they may be distributed and presented within the social networking service. For example, one or more recommendations may be distributed and presented to one or more second users of the social networking service who are linked with the first user within the social networking service. Accordingly, the second users may be persons that may be interested in receiving gift recommendations corresponding to the first user.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

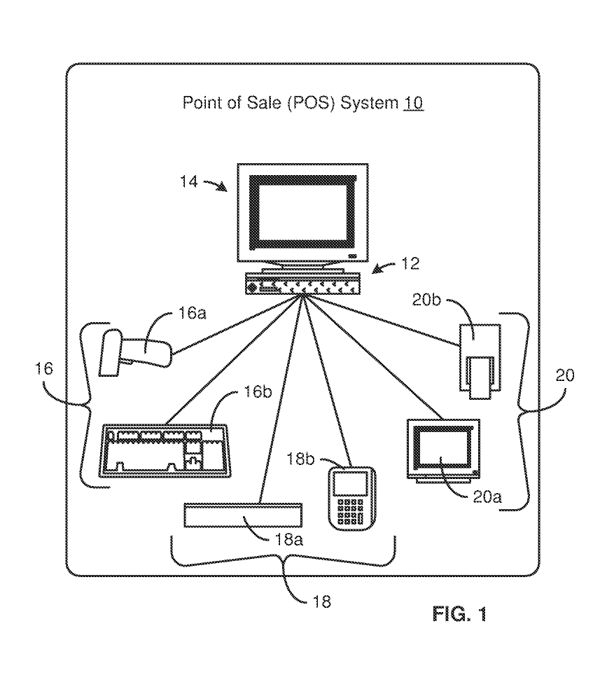

Referring to FIG. 1, in selected embodiments, the hardware, software, or hardware and software of a POS system 10 may be configured to implement one or more methods in accordance with the present invention. For example, a POS system 10 may be manufactured, programmed, modified, or upgraded to support collection of receipt data that can be used in generating one or more gift recommendations.

A POS system 10 in accordance with the present invention may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 in accordance with the present invention may include an accounting interface to pass certain information to one or more in-house or independent accounting applications.

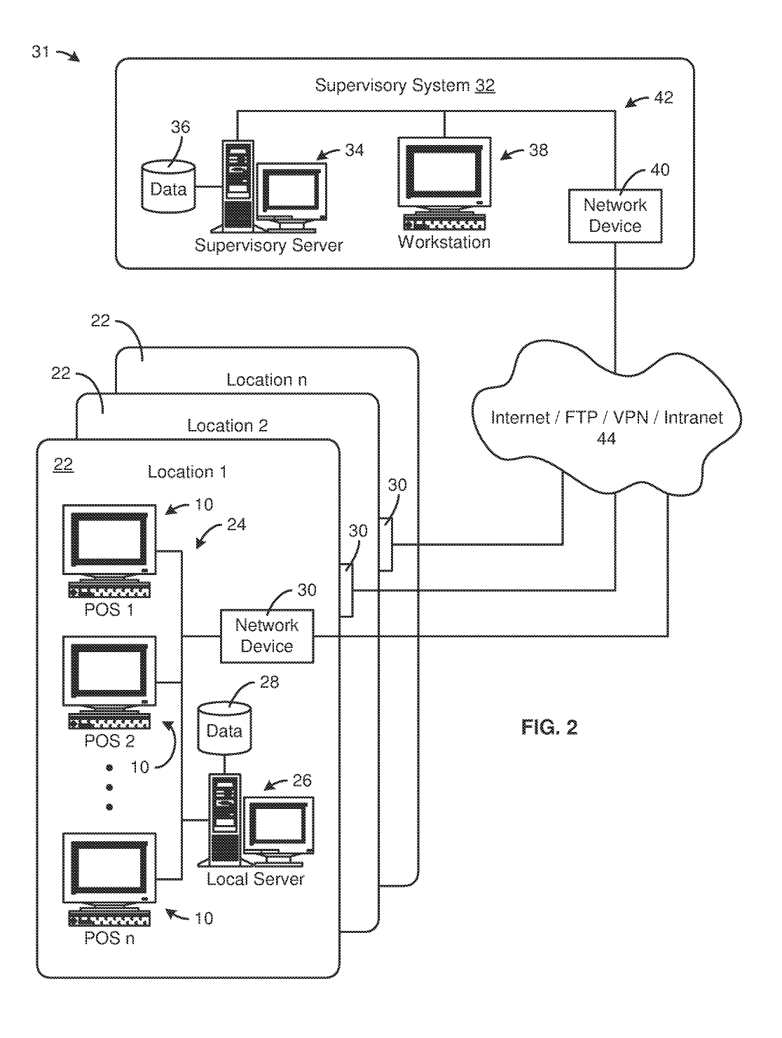

Referring to FIG. 2, in selected embodiments, a POS system 10 may operate substantially independently, as a stand-alone unit. Alternately, a POS system 10 in accordance with the present invention may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 in accordance with the present invention may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

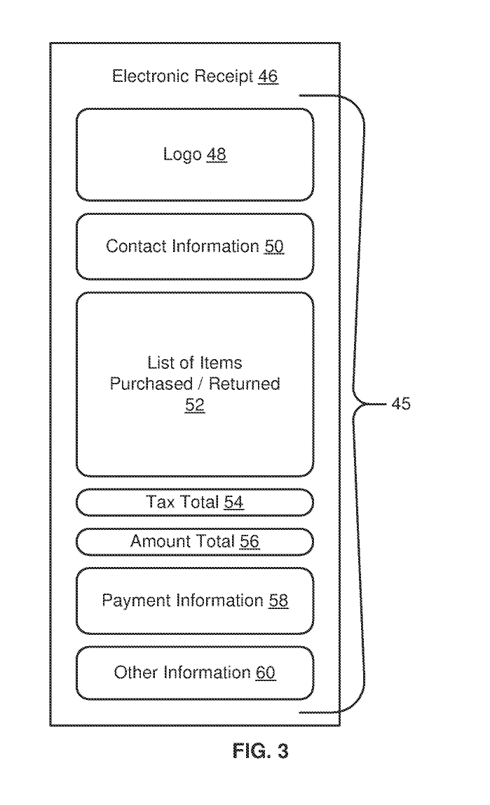

Referring to FIG. 3, a POS system 10 may collect and/or generate receipt data 45. Receipt data 45 may document a transaction (e.g., sale or return) carried out by a POS system 10. Receipt data 45 may be presented or displayed to a customer in the form of an electronic (e.g., paperless) receipt 46. In selected embodiments, receipt data 45 may be delivered to a customer's computing device (e.g., a mobile telephone, personal digital assistant (PDA), media player, tablet computer or reader, laptop computer, desktop computer, or the like, hereinafter a “computing device”) by an entity's computer system (e.g., a system comprising one or more POS systems 10, local servers 26, supervisory servers 34, some other onsite resources, some other offsite resources, or the like or combinations or sub-combinations thereof, hereinafter a “computer system”).

In selected embodiments, receipt data 45 and an electronic receipt 46 may include a logo 48, contact information 50, a list 52 of items purchased or returned, a total 54 indicating the sales tax assessed or returned, a total 56 indicating the amount paid or returned, payment information 58, other information 60, or the like or combinations or sub-combinations thereof.

A logo 48 may reinforce the brand and image of the associated entity within the mind of a consumer. By including contact information 50 on an electronic receipt 46, an entity may ensure that a customer has ready access to one or more physical addresses, Internet address, telephone numbers, facsimile numbers, hours of operation, or the like or combinations or sub-combinations thereof. One or more of a list 52 of items purchased or returned, a total 54 indicating the sales tax assessed or returned, a total 56 indicating 56 the amount paid or returned, and payment information 58 (e.g., date of transaction, an indication of method of payment, an indication of which credit or debit card was used, etc.) may be included to document important details of a transaction.

Other information 60 may be included within an electronic receipt 46 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

An electronic receipt 46 may be presented by a computing device of a customer in any suitable layout or format. For example, the receipt data 45 forming an electronic receipt 46 may simply be presented as a textual list. Alternatively, an electronic receipt 46 may follow the form of a paper receipt. That is, the electronic receipt 46 may comprise a virtual representation or layout substantially matching what a comparable paper receipt would look like.

The manner in which an electronic receipt 46 is presented or displayed on a computing device of a customer may be completely dictated by the computer system delivering the receipt data 45 thereto. Alternatively, the computing device of the customer may have an application (e.g., a receipt manager, accounting program, budgeting program, or the like) installed thereon. Such an application may partially or completely control the layout or format of an electronic receipt 46 displayed therewith or therethrough. For example, a computer system may supply receipt data 45, while the application installed on the computing device of the customer supplies the layout or formatting.

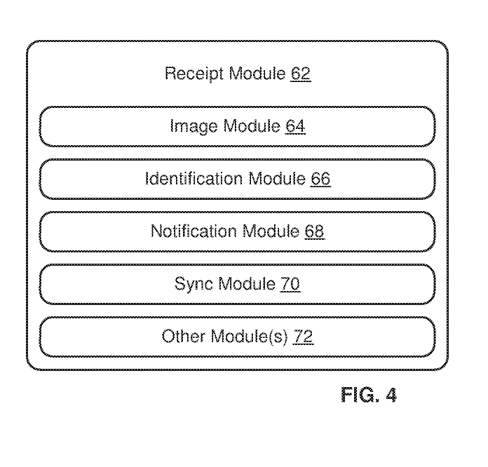

Referring to FIG. 4, a computer system in accordance with the present invention may deliver receipt data 45 to a computing device of a customer in any suitable manner. In selected embodiments, a receipt module 62 may enable or support such delivery. A receipt module 62 may include any suitable arrangement of sub-components or modules. In certain embodiments, a receipt module 62 may include an image module 64, identification module 66, notification module 68, synchronization module 70, one or more other modules 72 as desired or necessary, or the like or some combination or sub-combination thereof.

An image module 64 may assemble, generate, or obtain an advertisement containing a call to action for display on a receipt (e.g., paper receipt), customer-facing display 20a, or the like. In selected embodiments, a call to action may invite or motive a consumer to download receipt data 45. To increase the likelihood that a consumer will respond favorably to the call to action, an advertisement may include an enabler facilitating the desired step or action. For example, in selected embodiments, an advertisement may include a machine-readable code. By scanning the code (e.g., scanning the code using a camera on a mobile telephone, tablet computer, or the like), a consumer may import receipt data 45 encoded within the code. Alternatively, scanning the code may initiate the download of receipt data 45.

For example, a machine-readable code may be encoded with a URL. In addition to designating a particular resource, a URL may also include a transaction identification (ID). Accordingly, after an appropriate application is launched and a machine-readable code is scanned, a URL may be passed from a customer (e.g., from a mobile telephone of a customer) to an Internet Service Provider (e.g., a telecommunications provider). As a result, an appropriate resource within a computer system may be accessed and receipt data may be returned to (e.g., downloaded by) a computing device.

In selected embodiments, a machine-readable code may comprise a barcode. For example, in certain embodiments, a machine-readable code may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

An identification module 66 may be tasked with requesting, collecting, and/or communicating identification information linking a customer associated with a transaction with one or more records stored within a computer system. For example, as part of a transaction carried out at a POS system 10, an identification module 66 may request, collect, and/or communicate identification information linking a transaction to a particular computing device corresponding to the customer participating in the transaction. Thus, information corresponding to the transaction may be passed to the customer via the particular computing device.

An identification module 66 may request, collect, and/or communicate one or more types of identification information. For example, in selected embodiments, an identification module 66 may collect a unique identification or membership number from a customer. This may be done when a membership card, club card, loyalty card, identification card, credit card, debit card, fingerprint or other biometric characteristic, or the like is scanned, input, or otherwise collected at a POS system 10. In other situations, a cashier or customer may type in a unique identification number, payment number, membership number, or the like at a POS system 10. For example, while a cashier is processing a transaction, a customer may be prompted via a card reader 18b, customer-facing display 20, or the like to enter (e.g., type in using the card reader 18b) a mobile telephone number corresponding to the customer. Alternatively, a cashier may type in a telephone number corresponding to the customer.

Once the identification information is received, it may be used directly (e.g., used directly to pass receipt data 45 to a computing device of a corresponding customer). Alternatively, or in addition thereto, the identification information may be linked to one or more previously stored computer records. Within such records, a computer system may find the information necessary to identify and communicate with a computing device of a corresponding customer.

A notification module 68 may assemble, generate, obtain, direct, and/or issue one or more push notifications. In selected embodiments, push notifications may be directed to a computing device of a customer. For example, when an appropriate application in not running on a computing device, push notifications may inform the customer that certain data or options are available (e.g., that a new electronic receipt 46 is available for download).

A synchronization module 70 may support or enable one way or two way data communication between a computer system and a computing device. For example, a synchronization module 70 may support or enable the passing of receipt data 45 from a computer system to a computing device. A synchronization module 70 may also enable certain data received from a computing device to be incorporated within or used by a computer system. For example, one or more user preferences (e.g., notification preferences) may be communicated to a computer system from an application resident on a computing device.

The various functions or modules of a receipt module 62 may be enacted or implemented by any suitable system or component thereof. For example, in selected embodiments, one or more functions or modules of a receipt module 62 may be distributed across one or more hardware devices, including a primary computer 12 of a POS system 10, a local server 26, a supervisory server 34, some other onsite resource, some other offsite resource, or the like or combinations or sub-combinations thereof. Thus, systems and methods in accordance with the present invention may be adapted to a wide variety of situations, including more rigid legacy systems.

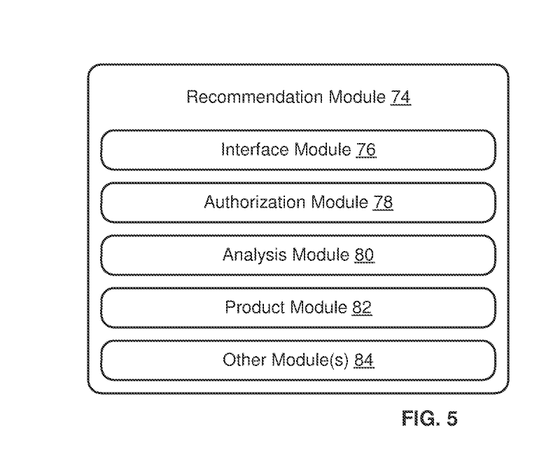

Referring to FIG. 5, in selected embodiments, receipt data 45 may be used to benefit a person (e.g., customer, user) whose purchases are documented in the receipt data 45. Alternatively, or in addition thereto, receipt data 45 may be used to benefit one or more other persons that are friends or relatives of the customer whose purchases are documented in the receipt data 45.

For example, receipt data 45 may be leveraged by a computer system in accordance with the present invention to assist in making recommendations that are relevant to a customer corresponding to the receipt data 45. In selected embodiments, a recommendation may comprise an identification of a commercially available product or service that may be a timely, appropriate, and relevant gift for the customer. Accordingly, a system may leverage receipt data 45 to serve both a customer and his or her friends by facilitating and improving a gifting process.

In certain embodiments, recommendations in accordance with the present invention may be facilitated, supported, generated, or output by a recommendation module 74. A recommendation module 74 in accordance with the present invention may include any suitable arrangement of sub-components or modules. In certain embodiments, a recommendation module 74 may include an interface module 76, authorization module 78, analysis module 80, product module 82, one or more other modules 84 as desired or necessary, or the like or some combination or sub-combination thereof.

An interface module 76 may interface (e.g., facilitate or enable communication, pass data, etc.) between a computing device, one or more components of a computer system, or the like or combinations or sub-combinations thereof and a computer environment within or through which one or more recommendations may be communicated or presented. For example, an interface module 76 may interface between a computing device of a customer and a social network (e.g., an online social network service) of which the customer is a member or participant.

An authorization module 78 may seek, obtain, transfer, and/or implement an authorization from a customer to access or use receipt data 45 documenting one or more purchases of the customer. For example, an authorization module 78 may request permission to use a customer's receipt data 45 when recommending gifts (e.g., gifts that may be relevant to the customer) to one or more persons linked to the customer within a particular social network. Alternatively, or in addition thereto, an authorization may collect and/or present one or more credentials enabling a recommendation module 74 or one or more components thereof to access receipt data 45 of a particular customer.

An analysis module 80 may analyze one or more data sets in identifying one or more recommendations based thereon. For example, an analysis module 80 may analyze receipt data 45 and identify one or more products that may be relevant to a customer whose purchases are documented in the receipt data 45. Alternatively, or in addition thereto, an analysis module 46 analyze one or more other data sets such as messages, posts, or the like within one or more social network services. For example, in selected embodiments, an analysis module 80 may consider a customer's messages and/or posts within a social network service and the customer's receipt data 45 when identifying one or more products that may be relevant to the customer.

An analysis module 80 in accordance with the present invention may follow or implement any suitable algorithm, methodology, or the like. Selected algorithms, methodologies, or the like may use machine learning, statistical methods, and/or heuristics based on a person's purchase data, as well as all known purchase data. In certain embodiments, an analysis module 80 may effect a classification of certain data or collection of items being analyzed. For example, an analysis module 80 may include an ensemble classifier such as a RANDOM FOREST model or system. Alternatively, or in addition thereto, an analysis module 80 may include or use other methodologies such as nearest neighbor search, or the like.

A product module 82 may seek, collect, store, and/or communicate information corresponding to or identifying one or more commercially available products or services. A product module 82 may collect, store, etc. data relative to only one business (e.g., only data related to products or services offered by a particular retailer). Alternatively, a product module 82 may collect, store, etc. data relative to a plurality of businesses, even those of competing retailers. In selected embodiments, information collected or stored by a product module 82 may be provided to or used by an analysis module 80. Accordingly, an analysis module 80 may cooperate with a product module 82 in making one or more recommendations of commercially available products or services.

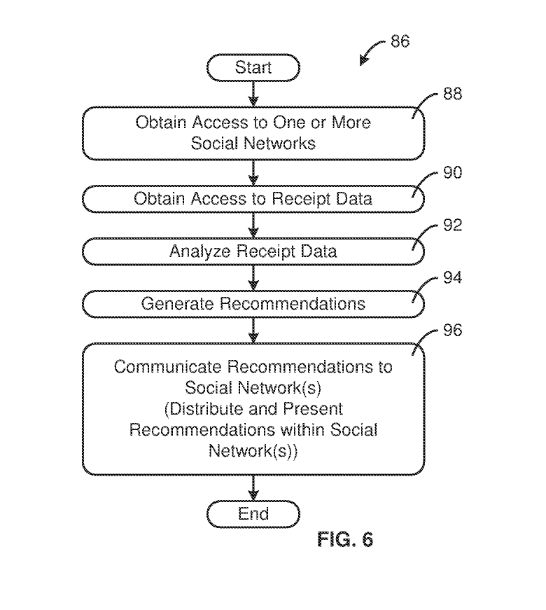

Referring to FIG. 6, a recommendation module 74 may facilitate or support certain methods in accordance with the present invention. One such method 86 may begin with obtaining 88 access to one or more socials networks. For example, an entity desiring to implement the method 86 may obtain 88 access to a computer-hosted social networking service (e.g., FACEBOOK or the like). The entity may also obtain 90 access to receipt data 45. Such data 45 may document one or more purchases made by a first human user of the social networking service. Accordingly, to better understanding the interests of the first user, a computer system may analyze 92 the receipt data 45. Such analysis 92 may include classifying various products or services whose purchase is documented in the receipt data 45.

Following the analysis 92, the computer system may have the information necessary to generate 94 one or more recommendations. For example, the computer system may identify, based at least in part on certain past purchases of the first user, one or more gifts that may be well suited to the first user. Once one or more recommendations have been generated 94, they may be communicated 96 or passed 96 to a social network. For example, one or more recommendations may be distributed and presented within the social network. Distribution of one or more recommendations to or within a social network may be performed directly or by a dedicated application running within a platform of the social network.

In selected embodiments, one or more recommendations may be distributed and presented to one or more second users of the social network. The second users may be persons connected to or linked with the first user within the social network. Accordingly, the second users may typically be the friends, relatives, co-workers, etc. of the first user. Thus, the second users may be persons that may be interested in receiving recommendations corresponding to the first user.

A recommendation in accordance with the present invention may be presented to a second user in any suitable manner. For example, a recommendation may be presented as or within a post, message, or the like. A recommendation may be presented directly or expressly. Alternatively, a recommendation may be prevented indirectly via a link (e.g., “click to see recommendation”). A recommendation may be presented to a second user and at any suitable time. For example, in selected embodiments, a recommendation may be presented to a second user a few days or weeks before a date that is important to the first user. The date may be a birthday, anniversary, holiday, or the like.

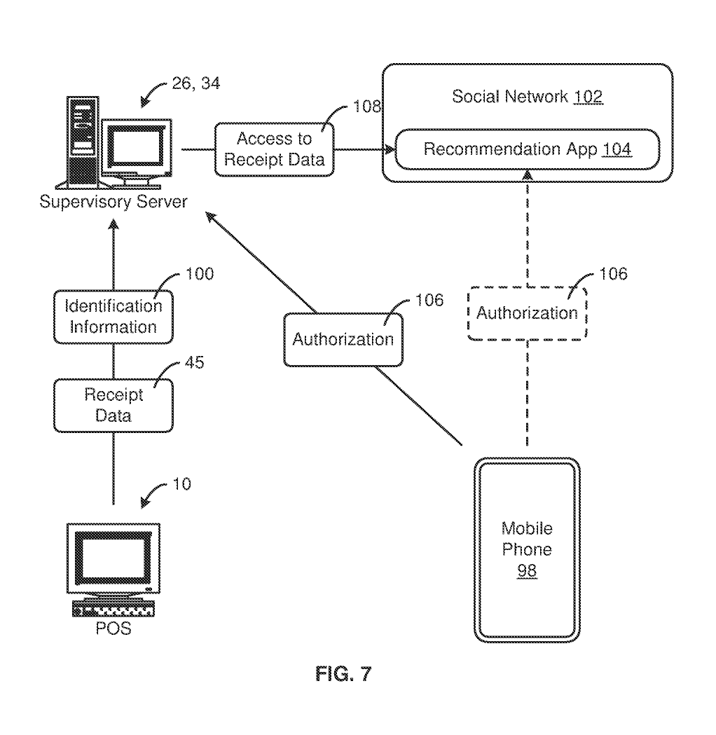

Referring to FIG. 7, one method in accordance with the present invention may begin when an application programmed to receive, format, display, categorize, and/or analyze receipt data 45 is installed on a computing device 98 (e.g., a mobile telephone 98 of a customer). A customer may then enter a “brick-and-mortar” business location (e.g., a brick-and-mortar retail store) and approach a POS system 10. At the POS system 10, a transaction (e.g., a purchase, return, or the like) may be initiated.

As part of a transaction, a customer may be identified. For example, a POS system 10 may scan a membership card, club card, loyalty card, identification card, credit card, debit card, fingerprint, or the like. From the scan, identification information 100 (e.g., a unique identification, card, or membership number) may be obtained. Alternatively, while a cashier is processing a transaction, a customer may be prompted via a card reader 18b, customer-facing display 20, or the like to enter (e.g., type in using the card reader 18b) an identification number (e.g., a mobile telephone number).

Identification information 100 may be passed from a POS system 10 to one or more other computers (e.g., servers 26, 34) within a computer system. The identification information 100 may link a customer and a corresponding transaction (e.g., current receipt data 45) to one or more records (e.g., past receipt data 45) stored within a computer system. In selected embodiments, such records may contain the information necessary to identify and communicate with a computing device 98 of the corresponding customer. Once a transaction has been completed, receipt data 45 may be passed from a POS system 10 to one or more other computers (e.g., servers 26, 34) within a computer system.

A customer corresponding to a particular computing device 98 may be associated with or use a social network 102 (e.g., an online social network service 102). In selected embodiments, a social network 102 may include, support, or operate in conjunction with a recommendation application 104. A recommendation application 104 may comprise a recommendation module 74 or one or more functions or modules thereof.

A recommendation application 104 may be programmed to identify items relevant to one user of the social network 102 and to deliver or communicate those items to one or more other users of the social network 102. For example, in association with an upcoming birthday of a first user, a recommendation application 104 may communicate one or more gift ideas or recommendations to one or more second users linked or otherwise associated to the first user within the social network 102.

At some point (e.g., in response to a prompt received from a recommendation application 104, recommendation module 74, or the like), a user may provide an authorization 106 for a recommendation application 104 to access or use his or her receipt data 45. An authorization 106 may be solicited and/or provided in any suitable manner. For example, in selected embodiments, an authorization 106 may be passed from a computing device 98 to a recommendation application 104. Alternatively, an authorization 106 may be passed from a computing device 98 to one or more computers within an enterprise system 31 (e.g., one or more servers 26, 34 or the like). In either case, once an authorization 106 has been granted, a recommendation application 104 may be provided (e.g., by one or more servers 26, 34 or the like) with access 108 to receipt data 45 of the user.

Given such access 108, a recommendation application 104 may identify one or more recommendations suitable to be communicated to selected persons associated with the user within the social network 104. Subsequent to such identification, a recommendation application 104 may communicate or present the one or more recommendations to one or more of the selected persons.

Care may be taken to preserve the privacy of the user whose receipt data 45 is being analyzed. One or more limitations to preserve such privacy may be built into systems and methods in accordance with the present invention. For example, a recommendation application 104 or module 74 may not receive access to certain sensitive receipt data 45 (e.g., payment information 58, identification of items purchased that fall within certain categories, or the like). Additionally, a recommendation application 104, recommendation module 74, or the like may have no ability to share receipt data 45 over a social network 102. Rather, an application 104, module 74, etc. may simply analyze the receipt data 45. An authorization 106 may provide a further limitation, limiting access 108 to receipt data 45 of users that do not wish to participate and/or limiting the communication or presentation of recommendations to certain groups, trusted individuals, or the like.

The various components of a system in accordance with the present invention may be controlled, owned, and/or operated by one or more entities (e.g., businesses, persons, etc.). For example, in selected embodiments, an enterprise-wide system 31 may correspond to a first entity, an online social networking service 102 may correspond to a second entity, a recommendation application 104 may correspond to a third entity, and a computing device 98 may correspond to a fourth entity. The first, second, third, and fourth entities may be independent from one another. Alternatively, certain components may be corresponding to a single entity.

For example, in selected embodiments, both an enterprise-wide system 31 and a recommendation application 104 or recommendation module 74 may correspond to a single entity or single group of related entities. In still other embodiments, a hybrid approach may be implemented. For example, a recommendation application 104 or recommendation module 74 may correspond to the same entity or groups of related entities as an enterprise-wide system 31. However, the recommendation application 104 or recommendation module 74 may run at least partially on hardware corresponding to a controller or owner of the online social networking service 102 and/or the computer device 98.

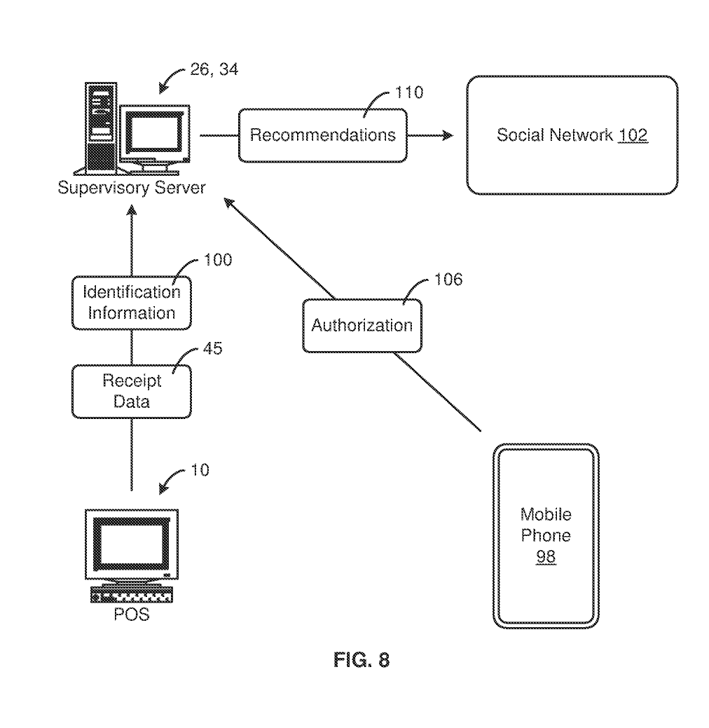

Referring to FIG. 8, in certain alternative embodiments, a recommendation module 74 or certain functions or modules thereof may be contained, supported, or provided by one or more computers (e.g., servers 26, 34 or the like) with an enterprise system 31. In such embodiments, an authorization 106 may be passed from a computing device 98 to one or more computers within an enterprise system 31. Additionally, rather than providing access 108 to receipt data 45, one or more computers within an enterprise system 31 may provide or output one or more recommendations 110 to a social network 102. For example, an enterprise system 31 may communicate or present one or more recommendations within a social network 102.

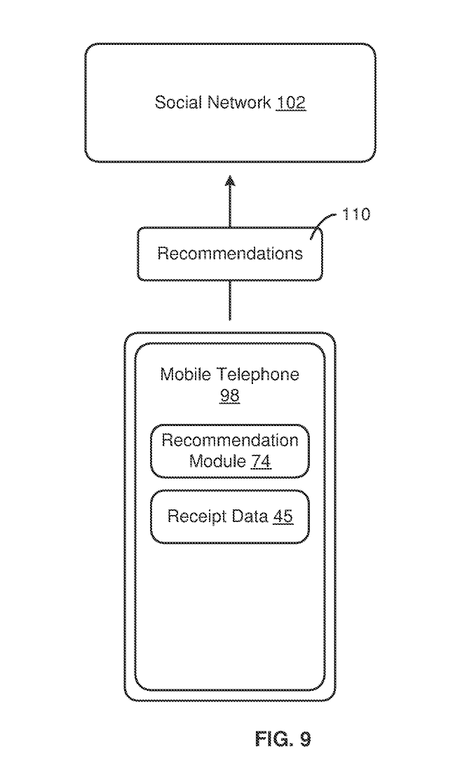

Referring to FIG. 9, in certain alternative embodiments, a recommendation module 74 or certain functions or modules thereof may be contained, supported, or provided by a computing device 98 (e.g., mobile telephone 98 or the like) of a user. In such embodiments, an authorization 106 may be collected and implemented by a computing device 98. Additionally, such a computing device 98 may store or have access to certain receipt data 45. Accordingly, a computing device 98 may provide or output one or more recommendations 110 to a social network 90. For example, an computing device 98 may communicate or present one or more recommendations within a social network 102.

The flowchart and block diagrams in FIGS. 6-9 illustrate the architecture, functionality, and operation of possible implementations of systems, methods, and computer program products according to certain embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for using receipt data within a social network, the method comprising:
obtaining, by a computer system, access to a computer-hosted social networking service;
obtaining, by the computer system, access to receipt data documenting one or more purchases made by a first human user of the social networking service;
classifying, by the computer system, the receipt data;
generating, by the computer system based at least in part on the classifying, one or more recommendations for gifts for the first human user; and
presenting, by the computer system via the social networking service, the one or more recommendations to a second human user of the social networking service.

2. The method of claim 1, wherein the obtaining access to receipt data comprises receiving, by the computer system, authorization from the first human user.

3. The method of claim 1, wherein the obtaining access to receipt data comprises obtaining access to receipt data documenting one or more purchases made by the first human user at a brick-and-mortar location.

4. The method of claim 1, wherein the second human user is linked within the social networking service to the first human user.

5. The method of claim 1, wherein the computer system comprises software running on a mobile computing device of the first human user.

6. The method of claim 1, wherein the computer system comprises software running on a computer within an enterprise-wide system.

7. The method of claim 1, wherein the computer system comprises a software application running within the social networking service.

8. The method of claim 1, wherein the classifying comprises applying, by the computer system, a learning algorithm comprising an ensemble classifier.

9. The method of claim 1, wherein the one or more recommendations each identify a commercially available product or service.

10. The method of claim 1, wherein the computer system comprises software propriety to a first entity running on hardware proprietary to one or more entities independent of the first entity.

11. A method for using receipt data within a social network, the method comprising:
obtaining, by a computer system, access to a computer-hosted social networking service;
obtaining, by the computer system, access to receipt data corresponding to a first human user of the social networking service, the receipt data documenting one or more purchases made by the first human user at a brick-and-mortar location;
classifying, by the computer system, the receipt data;
generating, by the computer system based at least in part on the classifying, one or more recommendations for gifts for the first human user; and
presenting, by the computer system via the social networking service, the one or more recommendations to a second human user of the social networking service, the second human user being linked to the first human user within the social networking service.

12. The method of claim 11, wherein the obtaining access to receipt data comprises receiving, by the computer system, authorization from the first human user.

13. The method of claim 11, wherein the computer system comprises software running on a mobile computing device of the first human user.

14. The method of claim 11, wherein the computer system comprises software running on a computer within an enterprise-wide system.

15. The method of claim 11, wherein the computer system comprises a software application running within the social networking service.

16. The method of claim 11, wherein the classifying comprises applying, by the computer system, a learning algorithm comprising an ensemble classifier.

17. The method of claim 11, wherein the one or more recommendations each identify a commercially available product or service.

18. The method of claim 11, wherein the computer system comprises software propriety to a first entity running on hardware proprietary to one or more entities independent of the first entity.

19. A computer system comprising:
one or more processors;
one or more memory devices operably connected to the one or more processors; and
the one or more memory devices collectively storing
an interface module programmed to interface with a computer-hosted social networking service,
an analysis module programmed to generate one or more classifications classify receipt data documenting one or more purchases of a first human user of the social networking service,
the analysis module further programmed to use the one or more classifications in generating one or more recommendations for gifts for the first human user, and
the interface module further programmed to deliver, via the social networking service, the one or more recommendations to a second human user of the social networking service.

20. The computer system of claim 19, further comprising an authorization module programmed to receiving from the first human user authorization to access the receipt data.
